(19) United States
(12) Patent Application Publication
(10) Pub. No.: US 2009/0064528 A1
(43) Pub. Date: Mar. 12, 2009

(54) Laundry treatment machine

(75) Inventor: Kyung Tae Kim, Changwon-si (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 12/230,706

(22) Filed: Sep. 3, 2008

(30) Foreign Application Priority Data
Sep. 4, 2007 (KR) 10-2007-0089502

(51) Int. Cl. F26B 21/00; A47L 9/30

(52) U.S. Cl. 34/82; 34/524; 362/91

(57) ABSTRACT

A laundry treatment machine capable of determining whether a lint filter is installed therein is provided. Therefore, it is possible to prevent the infiltration of foreign substance into a heater or a drum, which may be caused when a lint filter is not installed in a laundry treatment machine, and thus to prevent a fire or damage to laundry. In addition, it is possible to easily implement a lint filter detection device for determining whether a lint filter is installed in a laundry treatment machine.

This application claims priority from Korean Patent Application No. 10-2007-0089502 filed on Sep. 4, 2007 in the Korean Intellectual Property Office, the disclosure of which is incorporated herein by reference in its entirety.

### BACKGROUND OF THE INVENTION

1. Field of the Invention

The present invention relates to a laundry treatment machine, and more particularly, to a laundry treatment machine which can confirm whether a lint filter is installed therein.

2. Description of the Related Art

Laundry treatment machines are classified into washing machines removing dirt or dust from clothes or bedclothes by using water and detergent and using mechanical operations, dryers drying wet laundry by using a dry, hot wind generated by a heater and using mechanical operations, and combination washer dryers performing both a washing function and a drying function.

Laundry treatment machines such as a dryer or a combination washer dryer having a drying function are generally equipped with a lint filter for filtering out foreign substance such as fabric residues or dust in order to prevent a fire that may be caused when the foreign substance infiltrate into a heater.

Foreign substance collected by the lint filter accumulate in the lint filter. The lint filter may be installed in a laundry treatment machine so as to be able to be easily attached to or detached from the laundry treatment machine. Therefore, a user may periodically take the lint filter out from the laundry treatment machine and wash the lint filter clean.

However, the user may sometimes forget to put the lint filter back in the laundry treatment machine. In this case, foreign substance may not be able to be properly filtered out and may thus infiltrate into a heater of the laundry treatment machine. The foreign substance may also infiltrate into a drum of the laundry treatment machine and may thus cause a fire or damage to laundry in the drum.

### SUMMARY OF THE INVENTION

The present invention provides a laundry treatment machine which can confirm whether a lint filter is installed therein.

According to an aspect of the present invention, there is provided a laundry treatment machine including a lint filter which filters out foreign substance from a tub; a filter installation unit in which the lint filter is installed; a magnetic material which is disposed at one of the lint filter and the filter installation unit; and a sensor which is disposed at the other one of the lint filter and the filter installation unit and confirms whether the lint filter is installed in the filter installation unit based on a magnetic field generated by the magnetic material.

The laundry treatment machine may also include a control unit which confirms whether the lint filter is installed in the filter installation unit based on a signal provided by the sensor; and an alarm unit which outputs a warning signal indicating whether the lint filter is installed in the filter installation unit according to a signal provided by the control unit.

If the lint filter is confirmed yet to be installed in the lint filter installation unit, the control unit may terminate an operation of the laundry treatment machine.

According to another aspect of the present invention, there is provided a laundry treatment machine including a lint filter which filters out foreign substance from a tub; a filter installation unit in which the lint filter is installed; and an optical sensor which is disposed in the filter installation unit and confirms whether the lint filter is installed in the filter installation unit by emitting light to or receiving light from the lint filter.

The optical sensor may include a light emitter, which is disposed on one side of the filter installation unit and emits light toward the lint filter, and a light receiver, which is disposed on the other side of the filter installation unit and detects the light emitted by the light emitter.

The laundry treatment machine may include a control unit which confirms whether the lint filter is installed in the filter installation unit based on a signal provided by the optical sensor; and an alarm unit which outputs a warning signal indicating whether the lint filter is installed in the filter installation unit based on a signal provided by the control unit.

If the lint filter is confirmed not to be installed in the filter installation unit, the control unit may terminate an operation of the laundry treatment machine.

According to another aspect of the present invention, there is provided a laundry treatment machine including a lint filter which filters out foreign substance from a tub; a filter installation unit in which the lint filter is installed; and a switch which is disposed in the filter installation unit and confirms whether the lint filter is installed in the filter installation unit according to whether the switch is pressed by the lint filter.

The switch may be pressed in a direction in which the lint filter is inserted into the filter installation unit.

The switch may be turned on or off according to whether the switch is pressed by the lint filter.

The laundry treatment machine may also include a control unit which confirms whether the lint filter is installed in the filter installation unit based on a signal provided by the switch; and an alarm unit which outputs a warning signal indicating whether the lint filter is installed in the filter installation unit based on a signal provided by the control unit.

If the lint filter is confirmed not to be installed in the filter installation unit, the control unit may terminate an operation of the laundry treatment machine.

As described above, according to the present invention, it is possible to confirm whether a lint filter is installed in a laundry treatment machine. Therefore, it is possible to prevent the infiltration of foreign substance into a heater or a drum, which may be caused when a lint filter is not installed in a laundry treatment machine, and thus to prevent a fire or damage to laundry. In addition, it is possible to easily implement a lint filter detection device for determining whether a lint filter is installed in a laundry treatment machine.

### BRIEF DESCRIPTION OF THE DRAWINGS

The above and other features and advantages of the present invention will become more apparent by describing in detail preferred embodiments thereof with reference to the attached drawings in which:

FIG. 1 illustrates an exploded perspective view of a dryer according to an exemplary embodiment of the present invention;

FIG. 2 illustrates a cross-sectional view of a lint filter detection device according to an exemplary embodiment of the present invention;

FIG. 3 illustrates a cross-sectional view of a lint filter detection device according to another exemplary embodiment of the present invention;

FIG. 4 illustrates a cross-sectional view of a lint filter detection device according to another exemplary embodiment of the present invention;

FIG. 5 illustrates a cross-sectional view of a lint filter detection device according to another exemplary embodiment of the present invention; and

FIG. 6 illustrates a cross-sectional view of the lint filter detection device shown in FIG. 5 when a lint filter is installed in a lint duct.

### DETAILED DESCRIPTION OF THE INVENTION

The present invention will hereinafter be described in detail with reference to the accompanying drawings in which exemplary embodiments of the invention are shown.

A laundry treatment machine according to an exemplary embodiment of the present invention will hereinafter be described in detail, taking a dryer as an example.

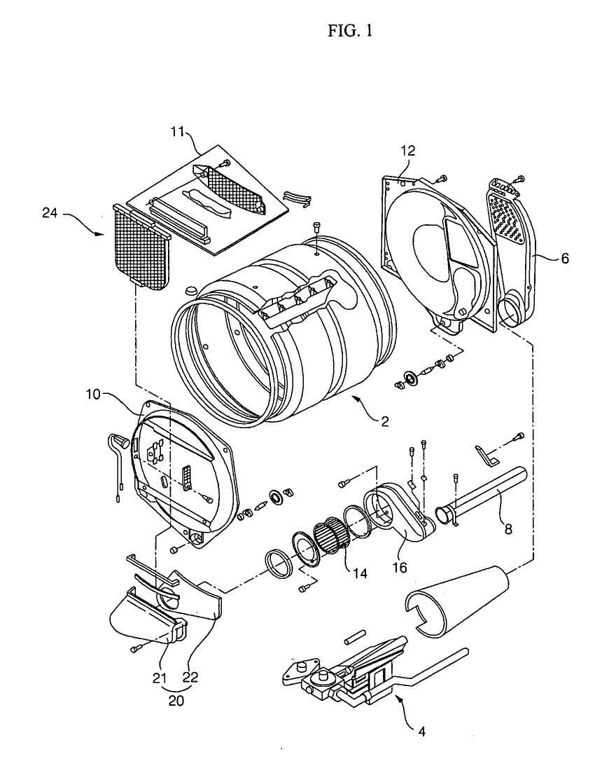

FIG. 1 illustrates an exploded perspective view of a dryer according to an exemplary embodiment of the present invention. Referring to FIG. 1, the dryer includes a drum 2, which is installed in a case (not shown) so as to be able to rotate and holds laundry, a heater 4, which is disposed outside the drum 2, a hot wind supply duct 6, which supplies a dry, hot wind transmitted through the heater 4 into the drum 2, an exhaust duct 8, through which air used to dry the laundry in the drum 2 is discharged from the drum 2, and a lint filter assembly, which is disposed between the drum 2 and the exhaust duct 8 and removes impurities from the air discharged from the drum 2.

A front supporter 10 is installed at the front of the drum 2, and a rear supporter 12 is installed at the rear of the drum 2. An outlet assembly 11, through which air is discharged from the drum 2, is disposed on one side of the front supporter 10.

The lint filter assembly includes a lint duct 20, which is disposed between the outlet assembly 11 and the exhaust duct 8, and a lint filter 24, which is installed in the lint duct 20 and removes foreign substance including lint. A blower 14 and a blower housing 16 are coupled between the lint duct 20 and the exhaust duct 8. The blower 14 blows air in the lint duct 20. The blower housing 16 surrounds the blower 14.

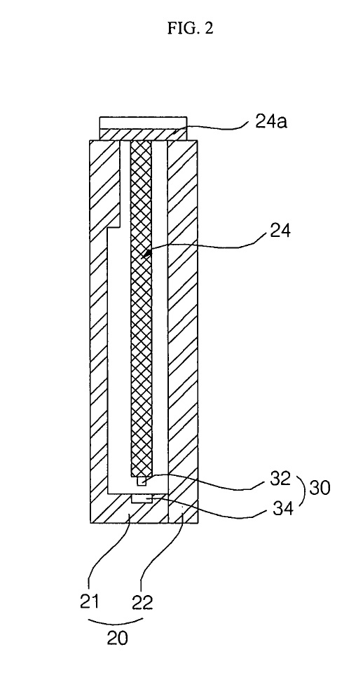

FIG. 2 illustrates a cross-sectional view of a lint filter detection device according to an exemplary embodiment of the present invention. Referring to FIG. 2, a lint duct 20 includes a rear duct 22, which is connected to the blower 14 shown in FIG. 1, and a front duct 21, which is disposed at the front of the rear duct 22 and forms an empty space with the rear duct 22 by being connected to the rear duct 22.

The lint duct 20 has an opening at the top, and thus, a lint filter 24 may be installed in the lint duct 20 through the opening.

The lint filter 24 includes a handle 24a, which is coupled to the top of the lint filter 24 and enables a user to grab the lint filter 24 and then detach the lint filter 24 from the lint duct 20.

Referring to FIG. 2, the lint filter detection device includes a lint filter detection module 30 which is provided between the lint filter 24 and the lint duct 20. The lint filter detection module 30 confirms whether the lint filter 20 is installed in the lint duct 20. The lint filter detection module 30 includes a magnetic material 32, which is disposed at the lint filter 20, and a sensor 34, which is disposed at the lint duct 20 and detects a magnetic field generated by the magnetic material 32.

The magnetic material 32 may be disposed at the bottom of the lint filter 24. The sensor 34 may be disposed at the front duct 21 and may face the magnetic material 32. A hall sensor may be used as the sensor 34.

The lint filter detection module 30 may also include a control unit (not shown), which confirms whether the lint filter 24 is installed in the lint duct 20 based on a signal transmitted by the sensor 34, and an alarm unit (not shown), which outputs a warning signal indicating whether the lint filer 44 is installed in the lint duct 40 based on a signal provided by the control unit.

The alarm unit may output an alarm sound through a speaker or may display a text message with the aid of a display device.

The operation of the lint filter detection module 30 will hereinafter be described in detail.

When a driving signal for the dryer is received from the user, the sensor 34 detects a magnetic field, if any, and measures the intensity of the magnetic field.

The control unit receives the result of the measurement performed by the sensor 34. The control unit compares the result of the measurement performed by the sensor 34 with a reference level and confirms whether the lint filter 24 is installed in the lint duct 20 based on the results of the comparison. The reference level may correspond to the intensity of a magnetic field when the lint filter 24 is installed in the lint duct 20.

If the lint filter 24 is installed in the lint duct 20, the result of the measurement performed by the sensor 34 may be the same as the reference level. Therefore, if the result of the measurement performed by the sensor 34 is the same as the reference level, the control unit may confirm that the lint filter 24 is installed in the lint duct 20, and may control the dryer to operate normally.

The lint filter 24 may be detached from the lint duct 20 for various purposes such as for washing the lint filter 24. If the lint filter 24 is put back in the lint duct 20 after being detached from the lint duct 20, the sensor 34 may not be able to detect any magnetic field. In this case, the result of the measurement performed by the sensor 34 does not reach the reference level. Thus, the control unit may confirm that the lint filter 24 is not installed in the lint duct 20. Thereafter, the control unit may terminate the operation of the dryer and may notify the user that the lint filter 24 is detached from the lint duct 20 with the aid of the alarm unit.

In this manner, the user may be able to recognize whether the lint filter 24 is installed in the lint duct 20. Thus, it is possible to prevent the dryer from operating when the lint filter 24 is not installed in the lint duct 20. Therefore, it is possible to prevent the infiltration of foreign substance into the heater 4 or the drum 2 and thus to prevent a fire or damage to laundry.

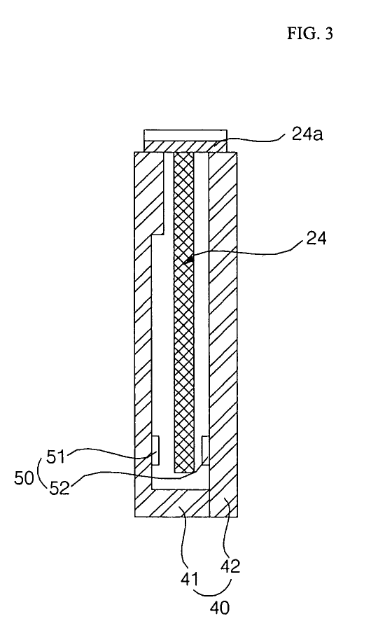

FIG. 3 illustrates a cross-sectional view of a lint filter detection device according to another exemplary embodiment of the present invention. Referring to FIG. 3, the lint filter detection device may include an optical sensor 50, which is installed in a lint duct 40 and confirms whether a lint filter 44 is installed in the lint duct 40 by emitting and receiving light.

The lint duct 40 may include a front duct 41, which is disposed at the front of the lint filter 44, and a rear duct 42, which is disposed at the rear of the front duct 41 and is coupled to the front duct 41.

A transmissive optical sensor may be used as the optical sensor 50. The optical sensor 50 may include a light emitter 51, which is disposed at the front duct 41, and a light receiver 52, which is disposed at the rear duct 42. The light emitter 51 and the light receiver 52 may face each other. More specifically, the light emitter 51 may be disposed on an inner lateral surface of the front duct 41 and may thus be able to emit light toward the rear duct 42, and the light receiver 52 may be disposed on an inner lateral surface of the rear duct 42 and may thus be able to detect the light emitted by the light-emitter 51.

The lint filter detection device may also include a control unit (not shown), which confirms whether the lint filer 44 is installed in the lint duct 40, and an alarm unit (not shown), which outputs a warning signal indicating whether the lint filer 44 is installed in the lint duct 40 based on a signal provided by the control unit. The control unit may receive a signal indicating the amount of light received by the light receiver 52 and may confirm whether the lint filter 44 is installed in the lint duct 40 based on the received signal.

The operation of the lint filter detection device according to the exemplary embodiment of FIG. 3 will hereinafter be described in detail.

When a driving signal for the dryer is received from the user, the light emitter 51 emits light toward the light receiver 52.

When the lint filter 44 is installed in the lint duct 40, at least some of the light emitted by the light emitter 51 is blocked by the lint filter 44. The light receiver 52 may detect the light emitted by the light emitter 51, and may transmit a signal indicating the results of the detection to the control unit.

The control unit compares the amount of light detected by the light receiver 52 with a reference value. If the amount of light detected by the light receiver 52 is less than the reference value, the control unit may confirm that some of the light emitted by the light emitter 51 has been blocked by the lint filter 44. Therefore, the control unit may confirm that the lint filter 44 is installed in the lint duct 40.

On the other hand, when the lint filter 44 is not installed in the lint duct 40, the light emitted by the light emitter 51 may all be detected by the light receiver 52. If the amount of light detected by the light receiver 52 is greater than the reference value, the control unit may confirm that the light emitted by the light emitter 51 has all been detected by the light receiver 52. Therefore, the control unit may confirm that the lint filter 44 is not installed in the lint duct 40.

In short, the control unit may confirm whether the lint filter 44 is installed in the lint duct 40 by comparing the amount of light emitted by the light emitter 51 and the amount of light detected by the light receiver 52.

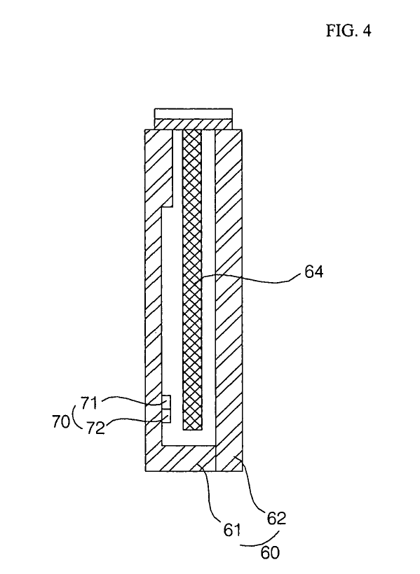

FIG. 4 illustrates a cross-sectional view of a lint filter detection device according to another exemplary embodiment of the present invention. Referring to FIG. 4, the lint filter detection device includes an optical sensor 70, which is installed in a lint duct 60 and confirms whether a lint filter 64 is installed in the lint duct 60 by emitting and receiving light. The exemplary embodiment of FIG. 4 is the same as the exemplary embodiment of FIG. 3 except that a reflective optical sensor may be used as the optical sensor 70, and thus, a detailed description of the structure of the lint filter detection device according to the exemplary embodiment of FIG. 4 will be omitted.

That is, the optical sensor 70 includes a light emitter 71, which is disposed on an inner lateral surface of a front duct 61 of the lint duct 60 and emits light toward a rear duct 62 of the lint duct 60, and a light receiver 72, which is disposed on an inner lateral surface of the front duct 61 and detects the light emitted by the light emitter 71 or light emitted from a lint filter 64.

The operation of the lint filter detection device according to the exemplary embodiment of FIG. 4 will hereinafter be described in detail.

When a driving signal for the dryer is received from the user, the light emitter 71 emits light.

When the lint filter 64 is installed in the lint duct 60, the light emitted by the light emitter 51 is reflected by the lint filter 64. Then, the light receiver 72 may detect the light reflected from the lint filter 64.

Thus, the amount of light detected by the light receiver 72 may vary according to whether the lint filter 64 is installed in the lint duct 60. Therefore, it is possible to confirm whether the lint filter 64 is installed in the lint duct 60 based on the amount of light detected by the light receiver 72.

More specifically, the lint filter detection device according to the exemplary embodiment of FIG. 4 may also include a control unit (not shown). The control unit compares the amount of light detected by the light receiver 72 with a reference value. If the amount of light detected by the light receiver 72 is less than the reference value, the control unit may confirm that the lint filter 64 is installed in the lint duct 60. Then, the control unit may terminate the operation of a dryer and may output a warning signal indicating that the lint filter 64 is not installed in the lint duct 60.

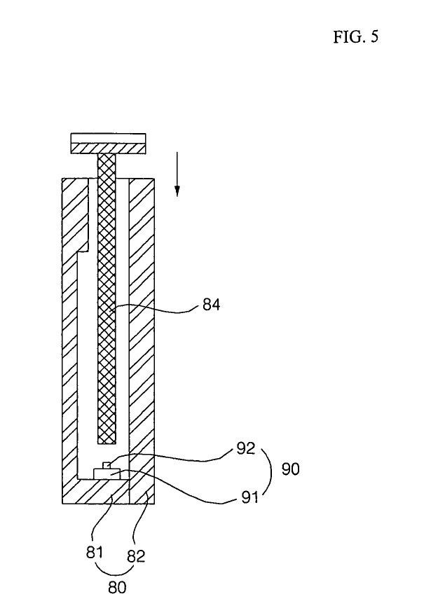

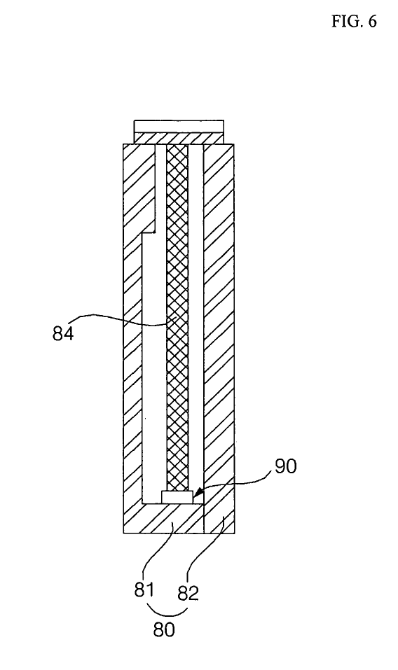

FIG. 5 illustrates a cross-sectional view of a lint filter detection device according to another exemplary embodiment of the present invention, and FIG. 6 illustrates a cross-sectional view of the lint filter detection device shown in FIG. 5 when a lint filter 84 is installed in a lint duct 80.

Referring to FIGS. 5 and 6, the lint filter detection device may include a switch 90, which is installed in the lint duct 80 so as to be able to be pressed by the lint filter 84.

The switch 90 may be pressed in a direction in which the lint filter 84 is inserted into the lint duct 80. The switch 90 may be turned on or off according to whether the switch 90 is pressed by the lint filter 84. The switch 90 may include a main body 91, which is installed at a front duct 81, and a pressing pin 92, which is coupled to the main body 91 so as to be able to be pressed.

The lint filter detection device according to the exemplary embodiment of FIG. 5 may also include a control unit (not shown), which confirms whether the lint filter 84 is installed in the lint duct 80 based on a signal provided by the switch 90, and an alarm unit (not shown), which outputs a warning signal indicating whether the lint filter 84 is installed in the lint duct 80 based on a signal provided by the control unit.

The operation of the lint filter detection device according to the exemplary embodiment of FIG. 5 will hereinafter be described in detail.

When the lint filter 84 is installed in the lint duct 80, the switch 90 is pressed by the lint filter 84 and is thus turned on. Then, an on-signal is transmitted to the control unit. Thus, the control unit confirms that the lint filter 84 is installed in the lint duct 80.

If the lint filter 84 is detached from the lint duct 80, the switch 90 may be turned off. Then, an off-signal is transmitted to the control unit. Thus, the control unit confirms that the lint filter 84 is not installed in the lint duct 80. Thereafter, the control unit may output a warning signal that the lint filter 84 is not installed in the lint duct 80, and may terminate the operation of a dryer.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A laundry machine comprising:
a lint filter;
a lint filter installation unit configured to receive the lint filter;
a magnetic material disposed on one of the lint filter and the lint filter installation unit; and
a sensor disposed on the other one of the lint filter and the lint filter installation unit; wherein the sensor is configured to detect a magnetic field generated by the magnetic material when the lint filter is installed in the lint filter installation unit.

2. The laundry machine of claim 1 further comprising:
a control unit configured to receive, from the sensor, a signal indicating whether the lint filter is installed in the lint filter installation unit.

3. The laundry machine of claim 2, wherein the control unit is further configured to prevent the laundry machine from operating if the lint filter is not installed in the lint filter installation unit.

4. The laundry machine of claim 2 further comprising:
an alarm unit configured to receive a signal from the control unit and, in response thereto, provide a notification as to whether the lint filter is installed in the lint filter installation unit.

5. A laundry machine comprising:
a lint filter;
a lint filter installation unit configured to receive the lint filter; and
an optical sensor, at least a portion of which is disposed on the lint filter installation unit, wherein the optical sensor, based on an amount of detected light, is configured to generate a signal indicating whether the lint filter is installed in the lint filter installation unit.

6. The laundry machine of claim 5, wherein the optical sensor comprises
a light emitter disposed on one side of the lint filter installation unit such that it emits light toward the lint filter; and
a light receiver disposed on another side of the lint filter installation unit such that the amount of light it receives is dependent upon whether the lint filter is installed in the lint filter installation unit.

7. The laundry machine of claim 5 further comprising:
a control unit configured to receive the signal generated by the optical sensor.

8. The laundry treatment machine of claim 7, wherein the control unit is configured to prevent the laundry machine from operating if the lint filter is not installed in the lint filter installation unit.

9. The laundry machine of claim 7 further comprising:
an alarm unit configured to receive a signal from the control unit and, in response thereto, provide a notification as to whether the lint filter is installed in the lint filter installation unit

10. A laundry machine comprising:
a lint filter;
a lint filter installation unit configured to receive the lint filter; and
a switch disposed on the filter installation unit, wherein the state of the switch is dependent upon whether the lint filter is installed in the lint filter installation unit.

11. The laundry machine of claim 10, wherein the lint filter comes into contact with the switch when it is installed in the lint filter installation unit, said contact causing the state of the switch to change.

12. The laundry machine of claim 10, further comprising:
a control unit configured to receive a signal as a function of the state of the switch, the signal indicating whether the lint filter is installed in the lint filter installation unit.

13. The laundry machine of claim 12, wherein the control unit is configured to prevent the laundry machine from operating if the lint filter is not installed in the lint filter installation unit.

14. The laundry machine of claim 12 further comprising:
an alarm unit configured to receive a signal from the control unit and, in response thereto, provide a notification as to whether the lint filter is installed in the lint filter installation unit.

15. A laundry machine comprising:
a lint filter;
a lint filter installation unit configured to receive the lint filter;
a sensor, at least a portion of which, is disposed on the lint filter installation unit; and wherein the sensor is configured to detect the presence of the lint filter when it is installed in the lint filter installation unit.

16. The laundry machine of claim 15, wherein the sensor is a magnetic sensor.

17. The laundry machine of claim 15, wherein the sensor is an optical sensor.

18. The laundry machine of claim 15, wherein the sensor is a switch.

19. The laundry machine of claim 19, wherein the switch is a mechanical switch.
